(19) United States
(12) Patent Application Publication
(10) Pub. No.: US 2026/0016603 A1
(43) Pub. Date: Jan. 15, 2026

(54) LIDAR DATA PROCESSING SYSTEM, METHOD AND COMPUTER-READABLE STORAGE MEDIUM

(71) Applicant: SUTENG INNOVATION TECHNOLOGY CO., LTD., Shenzhen (CN)

(72) Inventor: Yan ZHAO, Shenzhen (CN)

(73) Assignee: SUTENG INNOVATION TECHNOLOGY CO., LTD., Shenzhen (CN)

(21) Appl. No.: 19/263,469

(22) Filed: Jul. 8, 2025

(30) Foreign Application Priority Data
Jul. 11, 2024 (CN) 202410931483.0

(51) Int. Cl. G01S 17/89; G01S 7/48

(52) U.S. Cl. CPC G01S 17/89; G01S 7/4808

(57) ABSTRACT

A LIDAR data processing system includes a processing module, a storage module, a programming module, and a post-processing module, where the storage module includes a first storage unit and a second storage unit, the processing module is used to receive the sampling data, and the post-processing module is used to output the point cloud of the LiDAR. An input port of the first storage unit is connected to an output port of the processing module, and an output port of the first storage unit is connected to an input port of the programming module. An input port of the second storage unit is connected to an output port of the programming module, and an output port of the second storage unit is connected to the post-processing module.

### CROSS-REFERENCE TO RELATED APPLICATION

The present application claims the benefit of priority to Chinese Patent Application No. 202410931483.0, filed on Jul. 11, 2024, which is hereby incorporated by reference in its entirety.

### TECHNICAL FIELD

The embodiments of the present application relate to the technical field of LiDAR technology, and specifically to a LiDAR data processing system, method, and computer-readable storage medium.

### BACKGROUND

The working principle of LiDAR is to transmit a laser signal to a target object, and then appropriately process the received echo signal reflected from the target object to obtain relevant information of the target object, such as the distance between the LiDAR and the target object, direction, height, speed, attitude, and even shape, so as to detect, track, and identify various objects in the target scene.

The data pre-processing of the LiDAR generally refers to the process from receiving raw data from the time-to-digital converter (TDC) or the analog-to-digital converter (ADC) to forming a preliminary point cloud and storing it, while the corresponding data post-processing refers to image-level processing of the point cloud. Usually, the algorithm of data pre-processing directly determines the quality of the subsequent point cloud of the LiDAR. The prior art adopts the traditional method of hardening the pre-processing algorithm to a dedicated integrated circuit, but the dedicated integrated circuit can only be hardened according to a fixed pre-processing algorithm. After hardening, the algorithm module cannot be changed, which lacks flexibility and adaptability.

### SUMMARY

The embodiments of the present application provide a LiDAR data processing system, method, and computer-readable storage medium, aiming at achieving programmability of the LiDAR pre-processing process, thereby addressing the issue that existing LiDAR data pre-processing algorithms cannot be updated.

In a first aspect, an embodiment of the present application provides a LiDAR data processing system, including a processing module, a storage module, a programming module, and a post-processing module, where the storage module includes a first storage unit and a second storage unit, the processing module is used to receive sampling data, the sampling data is obtained by collecting the echo signal of the LiDAR, and the post-processing module is used to output the point cloud of the LiDAR. The input port of the first storage unit is connected to the output port of the processing module, the output port of the first storage unit is connected to the input port of the programming module; the input port of the second storage unit is connected to the output port of the programming module, and the output port of the second storage unit is connected to the post-processing module.

The data processing system addresses the inability of conventional LiDAR chips to update pre-processing algorithms, and modularizes the data processing system to enable adaptation to different types of receiving devices, thereby prolonging the life cycle of the chip.

In some embodiments, the programming module includes an on-chip programming unit and an off-chip programming unit. The on-chip programming unit is communicatively connected to the off-chip programming unit, the input port of the on-chip programming unit is connected to the output port of the first storage unit, and the output port of the on-chip programming unit is connected to the input port of the second storage unit.

The on-chip programming unit has high flexibility and efficiency, which is conducive to flexible adjustment of algorithms and extension of the life cycle of the chip. The off-chip programming unit can reduce the computing burden of the on-chip programming unit and reduce unnecessary power consumption.

In some embodiments, the processing module includes a data selector and a data processing channel. The data processing channel includes a computing channel and a pass-through channel. The data selector is used to select the data processing channel.

The above setting enables the processing module to perform differentiated processing of input data, thereby achieving partial adjustment of the pre-processing algorithm.

In some embodiments, the processing module includes a first processing unit and a second processing unit. Each processing unit includes the data selector and the data processing channel. The output port of the second storage unit is connected to the input port of the first processing unit, the output port of the first processing unit is connected to the input port of the second processing unit, the output port of the second processing unit is connected to the input port of the first storage unit, and the output port of the first storage unit is connected to the post-processing module.

The above setting enables the processing results of each processing unit on different nodes to be written back to the storage module, thereby allowing updates to the pre-processing algorithm, improving system adaptability, and prolonging the life cycle of the chip.

In a second aspect, an embodiment of the present application provides a LiDAR data processing method, which is applied to any of the above LiDAR data processing systems, including: receiving sampling data, obtaining first data according to the sampling data, where the sampling data is obtained by collecting the echo signal of the LiDAR, and the first data is obtained by processing the sampling data by the processing module; writing the first data into the first storage unit, obtaining second data according to the first data, where the second data is the data output by the programming module; writing the second data into the second storage unit, obtaining pre-processing data according to the second data, and the pre-processing data is the data output by the storage module to the post-processing module; and obtaining the point cloud of the LiDAR according to the pre-processing data.

The above method addresses the issue that the hardened pre-processing algorithm on the chip cannot be adjusted, introduces a write-back mechanism to the programming module, enables programmable pre-processing of sampling data, and helps to prolong the life cycle of the chip.

In some embodiments, the obtaining of the first data according to the sampling data includes: setting the operation mode of the processing module, where the operation mode includes an operation mode and a pass-through mode; and obtaining the first data according to the operation mode of the processing module and the sampling data.

In some embodiments, the obtaining of the second data according to the first data includes: an on-chip programming unit receives and processes the first data; and an off-chip programming unit receives the data output by the on-chip programming unit and obtains the second data according to the data output by the on-chip programming unit.

The above method reduces the computational burden of the on-chip programming unit and improves system efficiency and flexibility.

In some embodiments, the obtaining of the pre-processed data according to the second data includes: determining the second data as the pre-processed data.

In some embodiments, the obtaining of pre-processed data according to the second data includes: a first processing unit receives and transmits the second data; and a second processing unit receives the second data and obtains the pre-processed data according to the operation mode of the second processing unit and the second data.

The data pre-processing result of each node can be stored and called in the above manner, so as to realize the independent update and adjustment of each part of the pre-processing algorithm.

In a third aspect, an embodiment of the present application provides a computer-readable storage medium, where the computer-readable storage medium stores a computer program, and when the computer program is executed, any of the above-mentioned LiDAR data processing methods is performed.

### BRIEF DESCRIPTION OF DRA WINGS

In order to illustrate the technical solutions in the embodiments of the present application or the prior art more clearly, the drawings used in the embodiments or the prior art description are briefly introduced below. It is apparent that the drawings described below represent only certain embodiments of the present application. For ordinary technicians in this field, other drawings can be obtained based on these drawings without creative work.

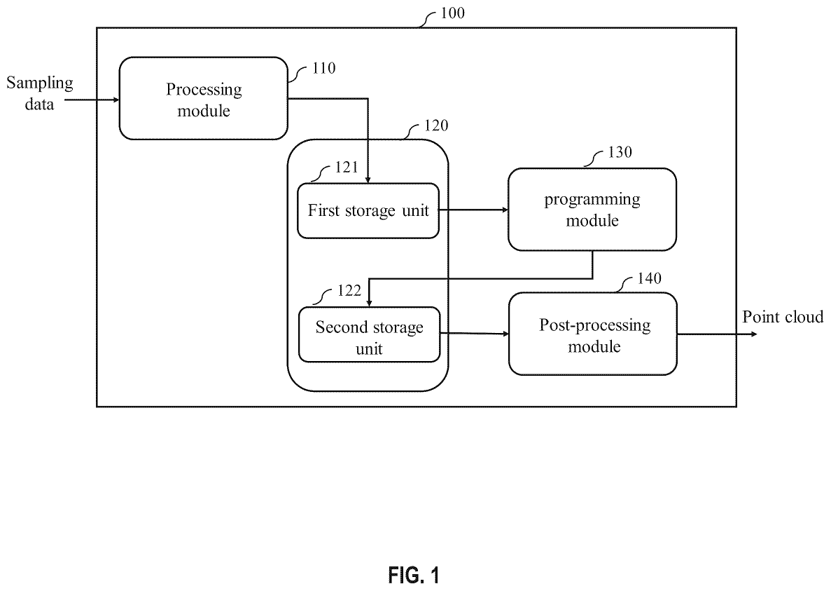

FIG. 1 illustrates a structural block diagram of a LiDAR data processing system provided in an embodiment of the present application;

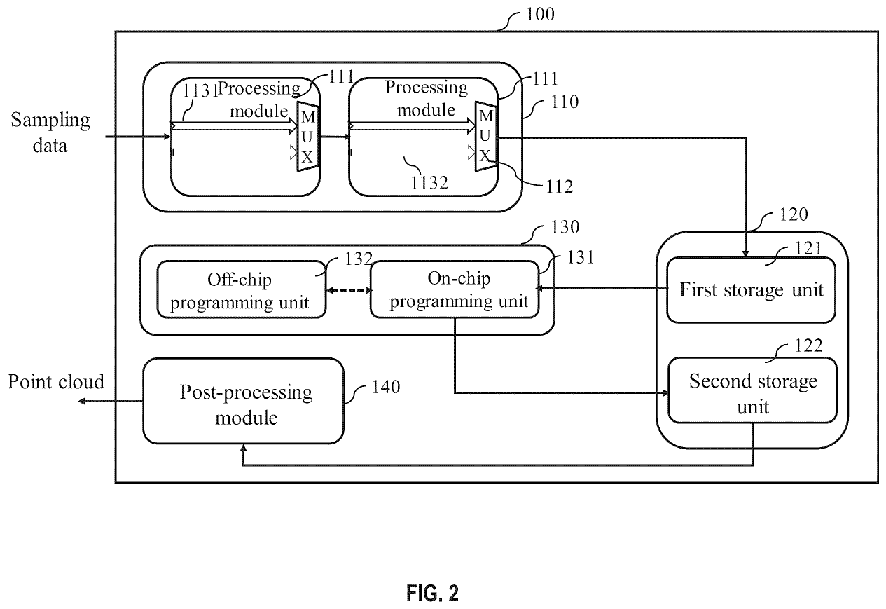

FIG. 2 illustrates a structural block diagram of a LiDAR data processing system provided in an embodiment of the present application;

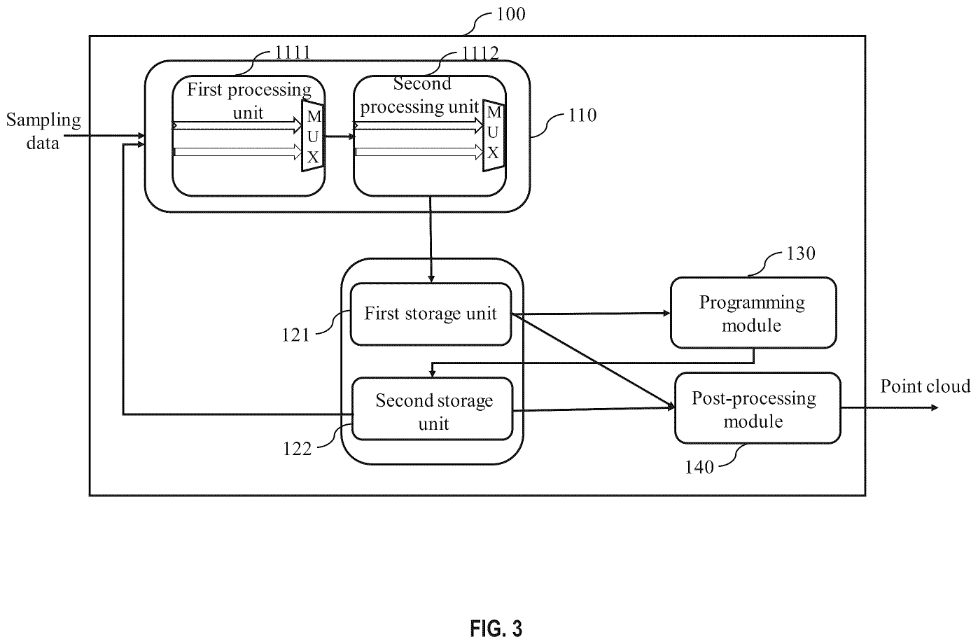

FIG. 3 illustrates a structural block diagram of a LiDAR data processing system provided in an embodiment of the present application;

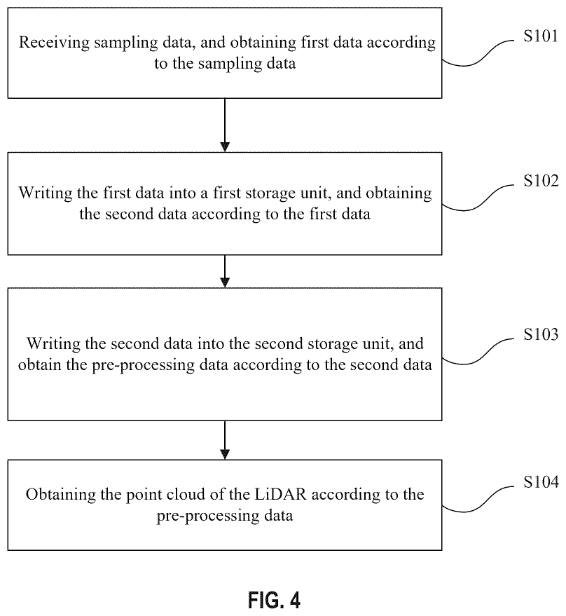

FIG. 4 illustrates a flow chart of a LiDAR data processing method provided in an embodiment of the present application;

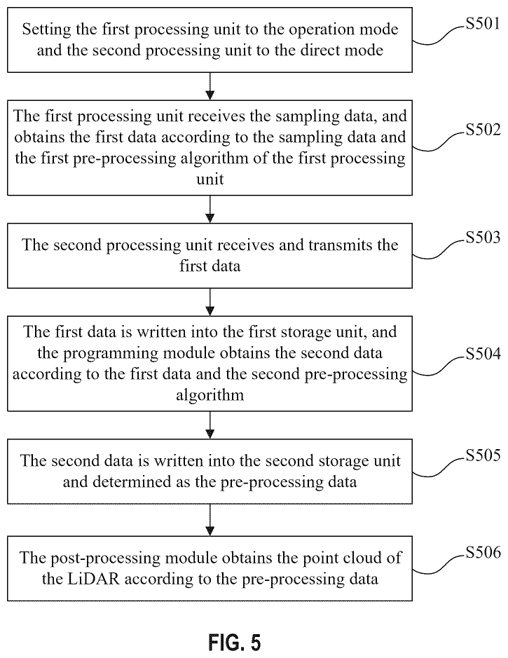

FIG. 5 illustrates a flow chart of a LiDAR data processing method provided in an embodiment of the present application;

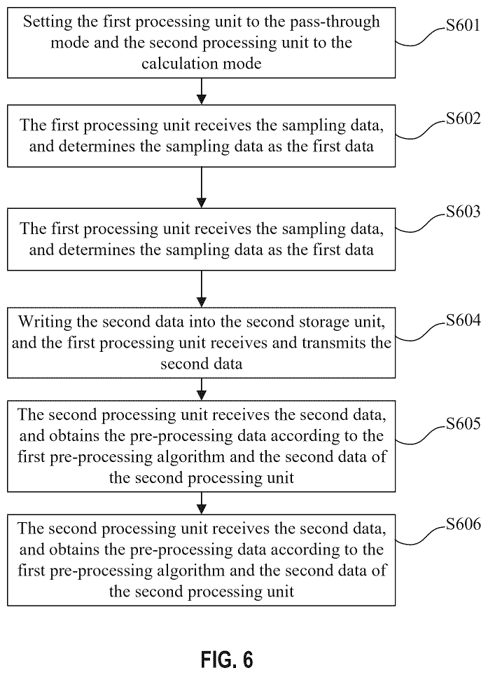

FIG. 6 illustrates a flow chart of a LiDAR data processing method provided in an embodiment of the present application; and

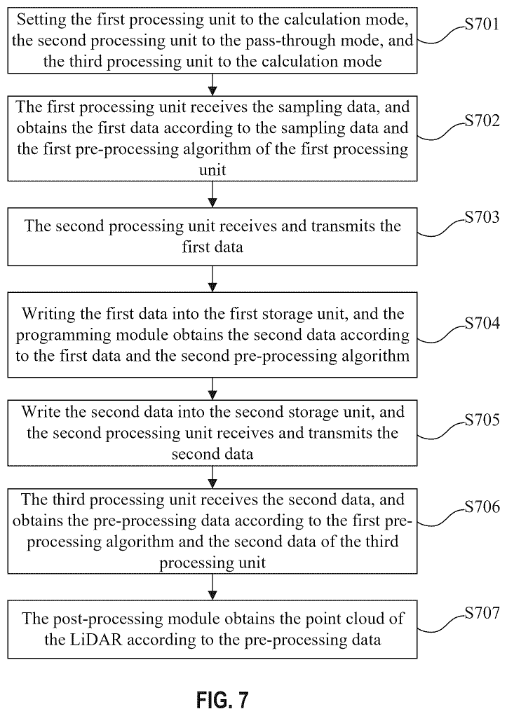

FIG. 7 illustrates a flow chart of a LiDAR data processing method provided in an embodiment of the present application.

### REFERENCE NUMERALS

100, LiDAR data processing system; 110, processing module; 111, processing unit; 1111, first processing unit; 1112, second processing unit; 112, data selector; 113, data processing channel; 1131, calculation channel; 1132, pass-through channel; 120, storage module; 121, first storage unit; 122, second storage unit; 130, programming module; 131, on-chip programming unit; 132, off-chip programming unit; 140, post-processing module.

### DETAILED DESCRIPTION

In order to make the purpose, technical solution, and advantages of the present application clearer, the embodiments of the present application will be further described in detail in conjunction with the drawings. When the following description refers to the drawings, unless otherwise indicated, the same numbers in different drawings represent the same or similar elements. The implementations described in the following exemplary embodiments do not represent all implementations of the present application. Instead, they are only examples of devices and methods consistent with some aspects of the present application as detailed in the appended claims.

Data preprocessing of LiDAR is a key step in the detection process. The result of data preprocessing directly affects the accuracy and efficiency of subsequent data analysis and application. Currently, LiDAR generally adopts the method of hardening the preprocessing algorithm to a dedicated integrated circuit. However, the preprocessing algorithm on the hardened dedicated integrated circuit is singular and fixed, and therefore cannot cope with the situation where adjustment of the preprocessing algorithms is needed. Chip replacement is complex and costly. Therefore, there remains a need for solutions that enable updating and flexible adjustment of the LiDAR preprocessing algorithm.

FIG. 1 illustrates a schematic structural block diagram of a LiDAR data processing system 100 provided in an embodiment of the present application. As shown in FIG. 1, an embodiment of the present application provides a LiDAR data processing system 100, including a processing module 110, a storage module 120, a programming module 130, and a post-processing module 140, where the storage module 120 includes a first storage unit 121 and a second storage unit 122, the processing module 110 is used to receive sampling data, the sampling data is obtained by collecting the echo signal of the LiDAR, and the post-processing module 140 is used to output the point cloud of the LiDAR. The input port of the first storage unit 121 is connected to the output port of the processing module 110, and the output port of the first storage unit 121 is connected to the input port of the programming module 130; the input port of the second storage unit 122 is connected to the output port of the programming module 130, and the output port of the second storage unit 122 is connected to the post-processing module 140.

The processing module 110, the storage module 120, the programming module 130, and the post-processing module 140 are electrically connected to each other directly or indirectly to achieve data transmission or interaction. For example, these modules can be electrically connected to each other through one or more communication buses or signal lines. In some embodiments, the first storage unit 121 and the programming module 130, as well as the second storage unit 122 and the programming module 130 are connected through an Advanced High Performance Bus (AHB). The AHB bus can connect high-performance modules such as RAM (random access memory), DMA (direct memory access), and DSP (digital signal processor) to form a complete system-level chip. That is, the programming module 130 can directly access and manipulate the storage module 120 through the AHB bus without going through other intermediate layers or bridge devices. The AHB bus also supports burst transmission and segmented transmission. The programming module 130 and the storage module 120 often have high requirements for data transmission speed and efficiency. These transmission methods can greatly improve the efficiency and flexibility of data transmission. The high performance characteristics of the AHB bus can ensure efficient and reliable data transmission between modules, especially in the field of LiDAR that requires high-performance data transmission and processing. The first storage unit 121 and the second storage unit 122 are respectively connected to the programming module 130 through the AHB bus, adding a write-back mechanism to the LiDAR data processing system, so that the programming module 130 can write the processed data back to the second storage unit 122 of the storage module 120 through the AHB bus.

In some embodiments, the processing module 110 is used to receive the sampling data and obtain the first data according to the sampling data. The first data is obtained by processing the sampling data by the processing module 110, and the first pre-processing algorithm refers to the pre-processing algorithm that has been hardened to the dedicated integrated circuit. In one embodiment, the processing module 110 receives the sampling data collected by the LiDAR, and performs logical operations on the sampling data according to the first pre-processing algorithm, for example, denoising, filtering, registration, correction, classification, etc., to preliminarily obtain accurate and reliable point cloud data (i.e., first data), providing a basis for subsequent data analysis and application.

In some embodiments, the storage module 120 is used to store data output by the processing module 110 and the programming module 130. The first storage unit 121 is used to receive and store data input by the processing module 110, and output data to the programming module 130. The second storage unit 122 is used to receive and store data input by the programming module 130, and output data to the post-processing module 140. The storage module 120 includes, but is not limited to, a random access memory (RAM), a read only memory (ROM), a programmable read-only memory (PROM), an erasable programmable read-only memory (EPROM), an electrically erasable read-only memory (EEPROM), etc.

In some embodiments, the programming module 130 is used to obtain the second data according to the first data. Among them, the second data is obtained by calculating the first data through the second pre-processing algorithm, and the second pre-processing algorithm refers to an algorithm used to replace the part that needs to be updated in the first pre-processing algorithm, which can be set according to actual conditions. The programming module 130 includes a processor, which is used to read the data stored in the storage module 120 and execute the second pre-processing algorithm to achieve the corresponding function. That is, the programming module 130 can further process the first data according to actual needs to obtain the second data, and then write the second data back to the storage module 120.

In some embodiments, the post-processing module 140 is used to obtain the point cloud of the LiDAR according to the pre-processing data. Specifically, the post-processing module 140 receives the pre-processing data transmitted by the storage module 120, performs image-level processing on the pre-processing data, and then outputs the point cloud of the LiDAR.

Based on the design shown in FIG. 1, the processing result of the processing module 110 is stored in the first storage unit 121 and then transmitted to the programming module 130. The programming module 130 performs programmable pre-processing operations and writes the processing results back to the storage module 120. The storage module 120 stores the pre-processing data after the operation and transmits it to the post-processing module 140 to obtain the point cloud of the LiDAR. The present application addresses the issue that conventional LiDAR chips cannot update the pre-processing algorithm, and provides a modularized data processing system can adapt to different types of receiving devices and prolong the life cycle of the chip.

In some embodiments, the programming module 130 includes an on-chip programming unit 131 and an off-chip programming unit 132. The on-chip programming unit 131 is communicatively connected with the off-chip programming unit 132, the input port of the on-chip programming unit is connected with the output port of the first storage unit 121, and the output port of the on-chip programming unit 131 is connected with the input port of the second storage unit 122.

In some embodiments, the programming module 130 further includes a communication unit for establishing a communication connection between the on-chip programming unit 131 and the off-chip programming unit 132 through a network, and for sending and receiving data through the network. In one embodiment, the communication unit is an Ethernet transceiver unit, and the on-chip programming unit 131 packages and sends the processed data to the off-chip programming unit 132 through the Ethernet transceiver unit. The data processed by the on-chip programming unit 131 is processed by the off-chip programming unit 132 according to a new pre-processing algorithm, and then transmitted back to the on-chip programming unit 131 through the Ethernet transceiver unit. The on-chip programming unit 131 writes the processing result of the off-chip programming unit 132 back to the second storage unit 122 of the storage module 120, and the second storage unit 122 transmits the data as pre-processing data to the post-processing module 140, thereby obtaining the point cloud of the LiDAR. In one embodiment, the off-chip programming unit 132 includes a field programmable gate array (FPGA). FPGA contains a large number of programmable logic gate circuits, programmable input and output modules, programmable internal interconnection structures, and programmable storage units. By programming the FPGA using a specific programming language, various complex digital logic circuits and systems can be implemented. FPGA allows users to configure hardware circuits according to their needs, unlike application-specific integrated circuits (ASICs) that require customized production. It can also quickly adapt to different application scenarios and demand changes by reprogramming without changing the hardware structure, and has high flexibility and efficiency. Therefore, when developing new products or improving existing products, there is no need to re-customize the chip, which is conducive to flexible adjustment of algorithms and extension of the chip life cycle. In addition, FPGA contains a large number of parallel processing units and high-speed interconnection networks, which can achieve high-performance data processing and calculation. The hardware characteristics of FPGA also enable it to handle tasks with high real-time and deterministic requirements, thereby effectively improving the real-time performance and accuracy of LiDAR data pre-processing. In addition, compared with traditional central processing units, FPGA can accurately configure hardware resources according to task requirements when performing specific tasks, has lower power consumption, avoids unnecessary power consumption, and reduces the computing burden of the on-chip programming unit 131.

In some embodiments, the processing module 110 includes a plurality of processing units 111. Each processing unit 111 includes a data selector 112 and a data processing channel 113. The data processing channel 113 includes a calculation channel 1131 and a pass-through channel 1132, and the data selector 112 is used to select the data processing channel 113.

The data selector 112 (Multiplexer, MUX) includes a selection control terminal and multiple data input terminals, which can select one from multiple input signals and send it to a single output line. The selection control input determines which data input will be passed to the output. In some embodiments of the present application, the data selector 112 includes two input terminals, a selection control terminal, and an output terminal. The two input terminals are a logic input terminal and a pass-through input terminal, respectively. The logic input terminal corresponds to the calculation channel 1131, and the pass-through input terminal corresponds to the pass-through channel 1132. The selection control terminal is used to determine whether the output data comes from the logic input terminal or the pass-through input terminal through the address selection signal. For example, when the address selection signal is 0, the data output by the processing unit 111 comes from the logic input terminal. When the address selection signal is 1, the data output by the processing unit 111 comes from the pass-through input terminal. In some embodiments, the data selector 112 is implemented using basic logic gates (such as AND, OR, and NOT gates). In other embodiments, the data selector 112 is implemented using an integrated circuit (such as a programmable logic device or a microprocessor).

The data processing channel 113 includes a calculation channel 1131 and a pass-through channel 1132, where the calculation channel 1131 is used to compute the input data according to the first pre-processing algorithm corresponding to the processing unit 111, and the pass-through channel 1132 is used to directly output the input data. The structural block diagram of this embodiment is shown in FIG. 2. Each processing unit 111 of the processing module 110 is provided with a calculation channel 1131 and a pass-through channel 1132. That is, the direct-through function is realized by adding a bypass, so that the processing results of each processing unit 111 on different nodes can be stored in the first storage unit 121 of the storage module 120, thereby achieving the purpose of partially adjusting the pre-processing algorithm and improving the flexibility and efficiency of the system.

In some embodiments, the processing module 110 includes a first processing unit 1111 and a second processing unit 1112, the output port of the second storage unit 122 is connected to the input port of the first processing unit 1111, the output port of the first processing unit 1111 is connected to the input port of the second processing unit 1112, the output port of the second processing unit 1112 is connected to the input port of the first storage unit 121, and the output port of the first storage unit 121 is connected to the post-processing module 140.

Referring to FIG. 3, the output port of the second storage unit 122 is connected to the input port of the first processing unit 1111, so that the second data can be input into the processing module 110 again for calculation; the output port of the second processing unit 1112 is connected to the input port of the first storage unit 121, and the output port of the first storage unit 121 is connected to the post-processing module 140, so that the pre-processed data obtained by the second data being processed again by the processing module 110 can be stored in the first storage unit 121, and directly output from the first storage unit 121 to the post-processing module 140. Exemplarily, the first processing unit 1111 receives the sampling data, the data selector 112 of the first processing unit 1111 selects the pass-through channel 1132, and the data processor of the second processing unit 1112 selects the calculation channel 1131, then the sampling data is not operated in the first processing unit 1111, and is directly output to obtain the first data. The first storage unit 121 stores the first data, transmits the first data to the programming module 130, and the programming module 130 processes the first data through the second pre-processing algorithm (instead of the first pre-processing algorithm corresponding to the first processing unit 1111) to obtain the second data. The second storage unit 122 stores the second data, inputs the second data from the input port of the first processing unit 1111 and transmits it to the second processing unit 1112, and the second processing unit 1112 processes and outputs the second data according to the first pre-processing algorithm corresponding to the unit to obtain the pre-processed data. The first storage unit 121 stores the pre-processed data and transmits it to the post-processing module 140, and the post-processing module 140 obtains the point cloud of the LiDAR according to the pre-processed data. In this way, some algorithms in the pre-processing algorithm are adjusted, the adaptability of the system is improved, and the chip life cycle is extended.

In some embodiments, the output port of each processing unit 111 is connected to the input port of the first storage unit 121, and the input port of each processing unit 111 is connected to the output port of the second storage unit 122. In one embodiment, the processing module 110 includes a first processing unit 1111 and a second processing unit 1112. The output port of the first processing unit 1111 is connected to the input port of the second processing unit 1112 and the input port of the first storage unit 121, respectively. The input port of the first processing unit 1111 is connected to the output port of the second storage unit 122. The output port of the second processing unit 1112 is connected to the input port of the first storage unit 121, and the input port of the second processing unit 1112 is connected to the output port of the second storage unit 122. The configuration of this embodiment enables the data processing results of each processing unit 111 of the processing module 110 to be directly transmitted to the programming module 130. After the software performs programmable pre-processing operations on the data through the programming module 130, the operation results can also be directly input into the next processing unit 111 for the next pre-processing. The system can store and retrieve the data pre-processing results of each node, thereby enabling independent updating and adjustment of each part of the pre-processing algorithm.

In some embodiments, the processing module 110 includes one or more of the first processing unit 1111, the second processing unit 1112, the third processing unit, the fourth processing unit, the fifth processing unit, and the sixth processing unit. The first processing unit 1111 is used to smooth or low-pass filter the histogram superposition data; the second processing unit 1112 is used to perform echo detection, interception, and noise removal on the histogram superposition data; the third processing unit is used to solve the effective echo according to the half-value algorithm to obtain the distance information and area information of each echo; the fourth processing unit is used to calibrate and obtain more accurate distance value and reflectivity value according to the distance and area output by the solution; the fifth processing unit is used to limit the validity of the received data according to the angle deviation of the LiDAR's light-receiving and light-emitting path; and the sixth processing unit is used to fuse and select the data received from multiple scans at the same position.

The embodiment of the present application provides a LiDAR data processing method, which is applied to the LiDAR data processing system in the above embodiments, as shown in FIG. 4, the method includes:
Step 101: Receiving sampling data, and obtaining first data according to the sampling data, where the sampling data is obtained by collecting an echo signal of the LiDAR, and the first data is obtained by processing the sampling data by a processing module.
Step 102: Writing the first data into a first storage unit, and obtaining the second data according to the first data, where the second data is the data output by a programming module.
Step 103: Writing the second data into the second storage unit, and obtaining the pre-processing data according to the second data, where the pre-processing data is the data output by the storage module to the post-processing module.
Step 104: Obtaining the point cloud of the LiDAR according to the pre-processing data.

The processing module receives the sampling data obtained according to the echo signal of the LiDAR, processes the sampling data according to the hardened pre-processing algorithm, obtains the first data, and stores the first data in the first storage unit. The programming module further processes the first data by the new pre-processing algorithm to obtain the second data, and stores the second data in the second storage unit. The second storage unit outputs the pre-processing data obtained according to the second data to the post-processing module, and the post-processing module obtains the point cloud image of the LiDAR according to the pre-processing data. The method flexibly adjusts and updates the pre-processing algorithm of the LiDAR through the programming module, thereby enabling the programmability of the pre-processing algorithm. In addition, a write-back mechanism is provided in the programming module, such that the result (i.e., the second data) calculated by the programming module can be written back to the storage module, and then the post-processing module can obtain the point cloud image of the LiDAR based on the pre-processing data.

The implementation method of each step in the embodiment shown in FIG. 4 is described below:

In some embodiments, the implementation of the above step 101 includes the following S11 to S12.
S11: Setting an operation mode of the processing module, where the operation mode includes the operation mode and the direct mode.
S12: Obtaining the first data according to the operation mode of the processing module and the sampling data.

By setting the operation mode, the processing module 110 can perform different processing on the sampling data to achieve the adjustment of the pre-processing algorithm. If the processing module 110 is set to the operation mode, the processing module 110 processes the input data according to the hardened pre-processing algorithm and outputs the data after the logical operation. If the processing module 110 is set to the direct mode, the processing module 110 does not perform logical operation on the input data and directly outputs the unprocessed data. The setting of the direct mode can execute only the part that needs to be retained in the process of executing the hardened pre-processing algorithm, and use the pre-processing algorithm in the programming module to replace the pre-processing algorithm of the processing unit 111 in the direct mode to achieve the update of the pre-processing algorithm.

In some embodiments, the processing module 110 includes one or more of the above first processing unit 1111, the second processing unit, the third processing unit, the fourth processing unit, the fifth processing unit, and the sixth processing unit, then for each processing unit 111, the above S11-S12 are executed to determine the pre-processing algorithm according to the operation mode of each processing unit 111, so as to obtain the first data.

In some embodiments, obtaining first data according to the operation mode of the processing module and the sampling data includes:

When the operation mode of the processing module is the calculation mode, obtaining first data according to the first pre-processing algorithm of the processing module and the sampling data.

When the operation mode of the processing module is the pass-through mode, determining the sampling data as the first data.

In some embodiments, the implementation of the above step 102 includes the following S21 to S23.
S21: The on-chip programming unit receives and processes the first data.
S22: The off-chip programming unit receives the data output by the on-chip programming unit, and obtains the second data according to the data output by the on-chip programming unit

Both the on-chip programming unit 131 and the off-chip programming unit 132 can perform programmable pre-processing operations on the first data. That is, the part of the hardened algorithm of the processing module 110 that needs to be adjusted can be updated in the on-chip programming unit 131 and the off-chip programming unit 132 to complete the pre-processing of the sampling data. At the same time, the off-chip programming unit 132 can reduce the computational burden of the on-chip programming unit 131.

In some embodiments, the implementation of the above step 103 includes S31.
S31: Determining the second data is as the pre-processing data.

When the second data does not need to be further processed, the second data is the sampling data that has completed the pre-processing, and the second data is output as the pre-processed data to obtain the point cloud.

In some embodiments, the implementation of the above step 103 includes S32 to S33.
S32: The first processing unit receives and transmits the second data.
S33: The second processing unit receives the second data, processes the second data according to the operation mode of the second processing unit, and obtains the pre-processing data.

In the case where the second data needs to be further processed, the second data is input into the processing module 110 again to complete the operation of the remaining processing units 111, and the data after the pre-processing operation is completed is output to the first storage unit 121, and is directly transmitted to the post-processing module 140 through the first storage unit 121.

In conjunction with the method 500 in FIG. 5, an exemplary description of a method for processing LiDAR data is given below.
S501: Setting the first processing unit to the operation mode and the second processing unit to the direct mode.
S502: The first processing unit receives the sampling data, and obtains the first data according to the sampling data and the first pre-processing algorithm of the first processing unit.
S503: The second processing unit receives and transmits the first data.
S504: The first data is written into the first storage unit, and the programming module obtains the second data according to the first data and the second pre-processing algorithm.
S505: The second data is written into the second storage unit and determined as the pre-processing data.
S506: The post-processing module obtains the point cloud of the LiDAR according to the pre-processing data.

In conjunction with FIG. 6, another exemplary description of processing LiDAR data is given below.
S601: Setting the first processing unit to the pass-through mode and the second processing unit to the calculation mode.
S602: The first processing unit receives the sampling data, and determines the sampling data as the first data.
S603: The first processing unit receives the sampling data, and determines the sampling data as the first data.
S604: Writing the second data into the second storage unit, and the first processing unit receives and transmits the second data.
S605: The second processing unit receives the second data, and obtains the pre-processing data according to the first pre-processing algorithm and the second data of the second processing unit.
S606: The second processing unit receives the second data, and obtains the pre-processing data according to the first pre-processing algorithm and the second data of the second processing unit.

In conjunction with FIG. 7, another exemplary description of processing LiDAR data is given below.
S701: Setting the first processing unit to the calculation mode, the second processing unit to the pass-through mode, and the third processing unit to the calculation mode.
S702: The first processing unit receives the sampling data, and obtains the first data according to the sampling data and the first pre-processing algorithm of the first processing unit.
S703: The second processing unit receives and transmits the first data.
S704: Writing the first data into the first storage unit, and the programming module obtains the second data according to the first data and the second pre-processing algorithm.
S705: Write the second data into the second storage unit, and the second processing unit receives and transmits the second data.
S706: The third processing unit receives the second data, and obtains the pre-processing data according to the first pre-processing algorithm and the second data of the third processing unit.
S707: The post-processing module obtains the point cloud of the LiDAR according to the pre-processing data.

By setting the processing unit 111 corresponding to the first pre-processing algorithm to be updated to the pass-through mode, not only the pre-processing algorithm of the processing unit 111 with continuous processing time sequence can be adjusted, but also the pass-through channel 1132 can be flexibly used to adjust the first pre-processing algorithm of the processing unit 111 separated in the processing module 110, thereby addressing the issue that the chip cannot update the pre-processing algorithm and extending the life cycle of the chip.

It should be noted that FIG. 7 only takes the processing module 110 including the first processing unit 1111, the second processing unit 1112, and the third processing unit as an example. In a specific implementation, if the processing module 110 includes more, such as the first processing unit 1111, the second processing unit 1112, the third processing unit, the fourth processing unit, and the fifth processing unit, the data can be pre-processed in the remaining three processing units according to a process similar to the processing method of the first processing unit 1111 and the second processing unit 1112 in FIG. 5 or FIG. 6. When the five processing units 111 of the processing module 110 have completed the processing, step 104 is entered to obtain the point cloud. In the embodiment of the present application, the processing order of multiple processing units 111 must be performed in sequence according to the pre-set processing order.

In some embodiments, the processing module 110 includes the first processing unit, the second processing unit, and the third processing unit, and the above step 101 includes:
setting the first processing unit to the operation mode, the second processing unit to the operation mode, and the third processing unit to the direct mode;
the first processing unit receives the sampling data, and obtains the first sub-data according to the sampling data and the first pre-processing algorithm of the first processing unit, where the first pre-processing algorithm of the first processing unit is used to perform finite impulse response filtering on the sampling data;
the second processing unit receives the first sub-data, and obtains the second sub-data according to the first sub-data and the first pre-processing algorithm of the second processing unit, where the first pre-processing algorithm of the second processing unit is used to intercept and remove noise from the first sub-data; and
the third processing unit receives the second sub-data, and determines the second sub-data as the first data.

Step 102 includes: the third processing unit writes the first data into the first storage unit, and the programming module obtains the second data according to the first data and the second pre-processing algorithm, where the second pre-processing algorithm is used to obtain the distance information and area information of the echo signal of the LiDAR according to the first data.

Obviously, those skilled in the art should understand that each module or each step of the above embodiments can be implemented by a general computing device, which can be concentrated on a single computing device or distributed on a network composed of multiple computing devices. In some embodiments, they can be implemented by a program code executable by a computing device, so that they can be stored in a storage device and executed by the computing device. In some embodiments, each module or each step of the above embodiment can be made into individual integrated circuit modules or multiple modules, or steps in them can be made into a single integrated circuit module for implementation. In the description of the embodiments of the present application, “module,” and “processor/control device” may include hardware, software, or a combination of the two. A module may include hardware circuits, various suitable sensors, communication ports, and memories, and may also include software parts, such as program codes, or a combination of software and hardware. The processor/control device may be a central processing unit, a microprocessor, an image processor, a digital signal processor, or any other suitable processor. The processor/control device has data and/or signal processing functions.

An embodiment of the present application also provides a computer-readable storage medium, which stores a computer program code. When the computer program code is run on a computer, the computer executes related steps to implement the LiDAR data processing method provided in the above-mentioned embodiments.

The computer-readable medium includes: any entity or device, recording medium, computer memory, read-only memory (ROM), random access memory (RAM), electric carrier signal, telecommunication signal and software distribution medium that can carry computer program code to the camera/electronic device. For example, a USB flash drive, a mobile hard disk, or an optical disk.

The embodiments of the present application also provide a computer program product. When the computer program product is run on a computer, the computer executes the above-mentioned related steps to implement the LiDAR data processing method provided in the above-mentioned embodiments.

The computer-readable storage medium, computer program product, or chip provided in the embodiments of the present application are each configured to execute the corresponding methods provided above. Accordingly, the beneficial effects achieved thereby may be understood with reference to the beneficial effects described in the corresponding methods above.

The foregoing embodiments are provided solely for the purpose of illustrating the technical solutions of the present application and are not intended to limit the scope thereof. Within the scope and spirit of the present application, the technical features described in the above embodiments, or in different embodiments, may be combined in various ways, and the steps recited may be performed in any suitable order. It will be understood by those skilled in the art that the technical solutions described in the above embodiments may be subject to modifications or that certain technical features may be replaced with their equivalents. Such modifications or substitutions shall not be construed as departing from the essence or scope of the technical solutions disclosed in the embodiments of the present application.

What is claimed is:

1. A system for processing LiDAR data, comprising:
a processing module, a storage module, a programming module, and a post-processing module, wherein
the storage module includes a first storage unit and a second storage unit, the processing module is used to receive sampling data, the sampling data is obtained by collecting an echo signal of a LiDAR, and the post-processing module is used to output a point cloud of the LiDAR;
an input port of the first storage unit is connected to an output port of the processing module, and an output port of the first storage unit is connected to an input port of the programming module; and
an input port of the second storage unit is connected to an output port of the programming module, and an output port of the second storage unit is connected to the post-processing module.

2. The system according to claim 1, wherein the programming module comprises an on-chip programming unit and an off-chip programming unit, and
wherein the on-chip programming unit is communicatively connected to the off-chip programming unit, an input port of the on-chip programming unit is connected to the output port of the first storage unit, and an output port of the on-chip programming unit is connected to the input port of the second storage unit.

3. The system according to claim 1, wherein the processing module comprises a data selector and a data processing channel, the data processing channel comprises a calculation channel and a pass-through channel, wherein the data selector is used to select the data processing channel.

4. The system according to claim 3, wherein the processing module comprises a first processing unit and a second processing unit, each of the first processing unit and the second processing unit comprises the data selector and the data processing channel; and
the output port of the second storage unit is connected to an input port of the first processing unit, an output port of the first processing unit is connected to an input port of the second processing unit, an output port of the second processing unit is connected to the input port of the first storage unit, and the output port of the first storage unit is connected to the post-processing module.

5. A method for processing LiDAR data, applied to a LiDAR, comprising:
receiving sampling data, and obtaining first data according to the sampling data, wherein the sampling data is obtained by collecting an echo signal of the LiDAR, and the first data is obtained by processing the sampling data by a processing module of the LiDAR;
writing the first data into a first storage unit, and obtaining second data according to the first data, wherein the second data is data output by a programming module of the LiDAR;
writing the second data into a second storage unit, and obtaining pre-processing data according to the second data, wherein the pre-processing data is data output by a storage module of the LiDAR to a post-processing module of the LiDAR; and
obtaining a point cloud of the LiDAR according to the pre-processing data.

6. The method according to claim 5, wherein obtaining the first data according to the sampling data comprises:
setting an operation mode of the processing module, wherein the operation mode comprises an operation mode and a direct mode; and
obtaining the first data according to the operation mode of the processing module and the sampling data.

7. The method according to claim 5, wherein obtaining the second data according to the first data comprises:
an on-chip programming unit receiving and processing the first data; and
an off-chip programming unit receiving data output by the on-chip programming unit, and obtaining the second data according to the data output by the on-chip programming unit.

8. The method according to claim 5, wherein obtaining the pre-processing data according to the second data comprises:
determining the second data as the pre-processing data.

9. The method according to claim 5, wherein obtaining the pre-processing data according to the second data comprises:
a first processing unit of the processing module receiving and transmitting the second data; and
a second processing unit of the processing module receiving the second data and obtaining the pre-processing data according to an operation mode of the second processing unit and the second data.

10. A non-transitory computer-readable storage medium storing a computer program, wherein when the computer program is executed, cause a processor to perform operations comprising:
receiving sampling data, and obtaining first data according to the sampling data, wherein the sampling data is obtained by collecting an echo signal of a LiDAR, and the first data is obtained by processing the sampling data by a processing module of the LiDAR;
writing the first data into a first storage unit, and obtaining second data according to the first data, wherein the second data is data output by a programming module of the LiDAR;
writing the second data into a second storage unit, and obtaining pre-processing data according to the second data, wherein the pre-processing data is data output by a storage module of the LiDAR to a post-processing module of the LiDAR; and
obtaining a point cloud of the LiDAR according to the pre-processing data.
